(19) United States
(12) Patent Application Publication
(10) Pub. No.: US 2006/0022493 A1
(43) Pub. Date: Feb. 2, 2006

(54) Motor vehicle with a convertible rear compartment

(76) Inventor: Richard E. Miller, Atlantic Beach, FL (US)

Correspondence Address: Richard Miller, 329 Ahern St. Apt. 3, Atlantic Beach, FL, 32233, US

(21) Appl. No.: 11/225,420

(22) Filed: Sep. 13, 2005

Related U.S. Application Data
(63) Continuation-in-part of application No. 10/858,333, filed on Jun. 1, 2004, now abandoned.
(60) Provisional application No. 60/474,977, filed on Jun. 2, 2003.

(51) Int. Cl. B60J 7/00

(52) U.S. Cl. 296/216.02

(57) ABSTRACT

A versatile vehicle has a hinged roof panel that may be opened and locked at a bulkhead frame, behind the rear seats of a front compartment, mating with a bulkhead frame and thereby sealing off the front compartment from a rear compartment. The rear compartment may be configured with seats for carrying passengers. The seats may be collapsible and/or removable, thereby enabling the rear compartment to be converted into a cargo area by collapsing or removing the seats. An additional roof panel may be provided for converting the rear compartment from an enclosed compartment to an open-air compartment while the first roof panel is locked against the bulkhead frame. A kit is also provided for converting a conventional SUV or VAN into a SUV or VAN having such features.

### RELATED APPLICATIONS

This is a Continuation in Part of U.S. patent application Ser. No. 10/858,333, filed Jun. 1, 2004, (now abandoned), which claims priority to U.S. Provisional Application 60/474,977, filed, Jun. 2, 2003.

### BACKGROUND

1. Field of the Invention

The invention relates to motor vehicles and, more particularly, to a versatile sport-Utility vehicle, station wagon or van having a roof panel that may be opened and locked in place bulkhead, behind the rear seat of a front compartment, thereby sealing the front compartment from a rear compartment that may be converted from a rear passenger-carrying area to rear cargo carrying compartment, each of which may be enclosed or open-air.

2. Background Description

Sport-utility vehicles, station wagons and vans, which are referred to collectively hereinafter as SUVs, have grown tremendously in popularity. Many consumers favor the interior space available in such vehicles. While such vehicles are quite versatile, their spacious interiors suffer shortcomings. For example, closed rear compartments of SUVs do not accommodate upright tall objects.

In sharp contrast, a cargo bay of a pick-up truck can easily carry objects that are substantially taller than the roof of the vehicle, but has very limited interior space. Additionally, the cargo bay of a pick-up truck is typically not enclosed and not equipped for carrying passengers.

Furthermore, because rear compartments of SUVs are not sealed from front compartments, there is significant risk of unintended intrusions of cargo, noise, dirt and cargo-related odors into the front compartment. Not only can such intrusions create a nuisance and soil a front compartment, but they may also present a health hazard and safety risk.

SUVs having roof openings in rear compartments are known in the art. Although such vehicles may accommodate tall objects, they do not include a cost-effective apparatus for efficiently and securely sealing the open-air rear compartment from the front compartment.

The invention is directed to overcoming one or more of the problems as set forth above.

### SUMMARY OF THE INVENTION

The invention solves the problems and/or overcomes the drawbacks and disadvantages of the prior art by providing, in one exemplary embodiment, a vehicle having a hinged roof panel that may be opened and locked at a bulkhead, behind the rear seat of a front compartment, thereby sealing off the front compartment from a rear compartment.

In another exemplary embodiment, a kit is provided for converting a conventional SUV into an SUV having a hinged roof panel that may be opened and locked at a bulkhead, behind the rear seat of a front compartment, thereby sealing off the front compartment from a rear compartment.

The rear compartment may be configured as a passenger compartment that can be converted into a cargo compartment, such as by collapsing or removing seats. The rear compartment may also be configured as an enclosed compartment, with an exterior roof panel sealing a roof opening above the rear compartment. The exterior roof panel may be adapted for pivotal movement and locking against an interior panel at the bulkhead. Additionally (or in the alternative), the exterior roof panel may be retractable, i.e., adapted for sliding motion substantially parallel to the fixed roof. Upon sliding the retractable exterior roof panel forward, the rear compartment may be converted into an open-air compartment.

### BRIEF DESCRIPTION OF THE DRAWINGS

The foregoing and other objects, features and advantages of the present invention will become better understood with reference to the following description, appended claims, and accompanying drawings, where:

FIG. 1 conceptually provides a top view of a portion of a vehicle roof with a exemplary roof panel that may be opened in accordance with an embodiment of the invention;

FIG. 2 conceptually provides a rear vew of a vehicle with a cutaway section of the roof, the roof being equipped with an exemplary hinged roof panel in an vertical (i.e. folded down) position, thereby creating a bulkhead sealing the cargo compartment from the front compartment;

FIG. 3 conceptually provides a side view of an a portion of an exemplary hinged roof panel in closed, intermediate and opened position in accordance with an embodiment of the invention;

FIG. 4 conceptually shows a cutaway section of a portion of an exemplary roof panel and roof section in accordance with an embodiment of the invention;

FIG. 5 conceptually provides a top view of a portion of a vehicle roof with an exemplary roof panel that may be retracted in accordance with an embodiment of the invention;

FIG. 6 conceptually provides a top view of a portion of a vehicle roof with an exemplary roof panel that is retracted in accordance with an embodiment of the invention;

FIG. 7 provides a top view of a portion of a vehicle roof with an exemplary roof panel that is partially retractable and hinged in accordance with an embodiment of the invention;

FIG. 8 conceptually provides a rear view of a vehicle with a cutaway section of the roof, the roof being equipped with an exemplary hinged roof panel in a closed position, thereby sealing the roof opening;

FIG. 9 conceptually provides a side view of vehicle with a retractable roof panel in a closed position;

FIG. 10 conceptually provides a side view of a vehicle with a retractable roof panel in an opened position;

FIG. 11 conceptually provides a side view of a vehicle with a roof panel having a plurality of hingedly joined sections in an opened position;

FIG. 12 conceptually provides a side view of a hinged roof panel comprised of an interior roof panel and an exterior roof panel, each of which may be independently pivoted;

FIG. 13. Is a side view of one embodiment of a roof panel trolley and tracks located in a first position and a second position;

FIG. 14. Is a side view of the roof panel and the roof panel trolley; and

FIG. 15. Is a cut away, top view of a roof with the roof panel removed.

### DETAILED DESCRIPTION OF EMBODIMENTS OF THE INVENTION

An exemplary embodiment of the invention provides an apparatus for sealing an interior rear compartment from an interior front compartment of an SUV. An SUV includes an interior with a front compartment containing one or more rows of passenger seats. The SUV also includes a rear compartment, which may also include one or more rows of passenger seats. The rear compartment passenger seats may be removable and/or collapsible. With the passenger seats in place and an exterior roof panel in the closed position, the rear compartment becomes a separate area sealed from the front compartment and the elements. By removing or collapsing the passenger seats and opening the roof panel, the compartment converts into an open-air cargo carrying area.

A bulkhead is the demarcation between the front compartment and the rear compartment. In a preferred implementation, the bulkhead is located behind the front compartment passenger seat(s), but ahead of the side windows of the rear compartment. Location of the bulkhead at the side windows would create aesthetic and structural issues.

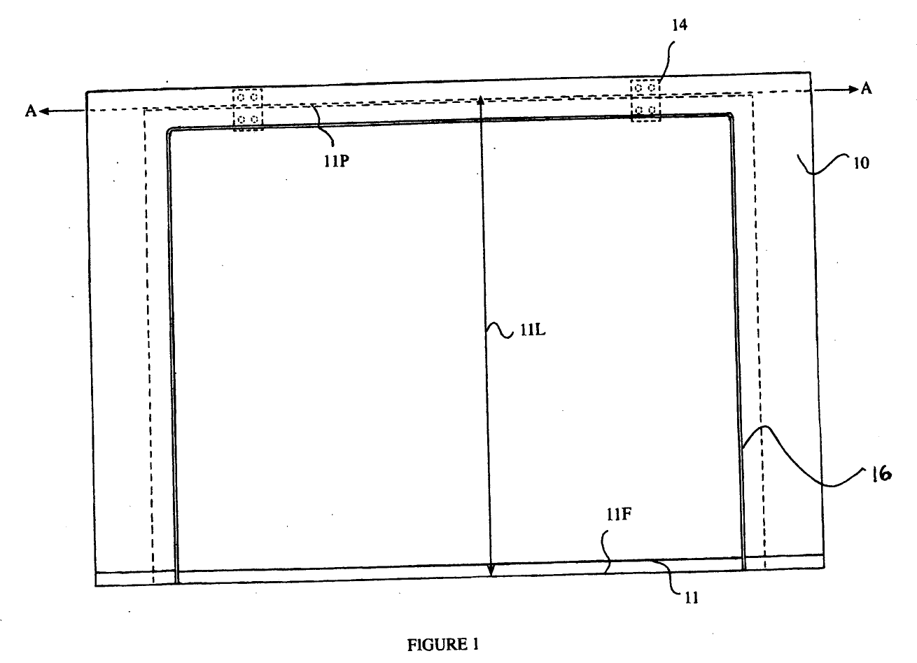

According to an embodiment of the invention, a roof panel from above the rear compartment may be opened and positioned to function as part of the bulkhead, thus partitioning a front compartment from a rear compartment. Referring now to FIG. 1, a top view of a portion of a vehicle roof with an exemplary roof panel 11 that may be opened in accordance with an embodiment of the invention is shown. The roof panel 11 is received within an opening 16 defined in the roof 10 above the rear compartment of the vehicle. In an exemplary embodiment, the roof panel is pivotally mounted at or adjacent to the front (pivotal) edge 11P of the panel. Hinges 14 (or other pivot devices) may be used for pivotal mounting. Thus, the panel may pivot about axis A-A at or near the front edge 11P of the roof panel 11. Conventional seals may be provided to ensure a weatherproof seal between the roof panel 11 and the roof 10. A conventional locking apparatus may also be provided to lock the roof panel 11 in a closed position.

The roof panel 11 may be comprised of a wide array of materials suitable for a roof component. By way of example and not limitation, the roof panel 11 may be composed of metals, plastics and/or glass and constructed in a manner suitable for conventional sunroofs or moon-roofs.

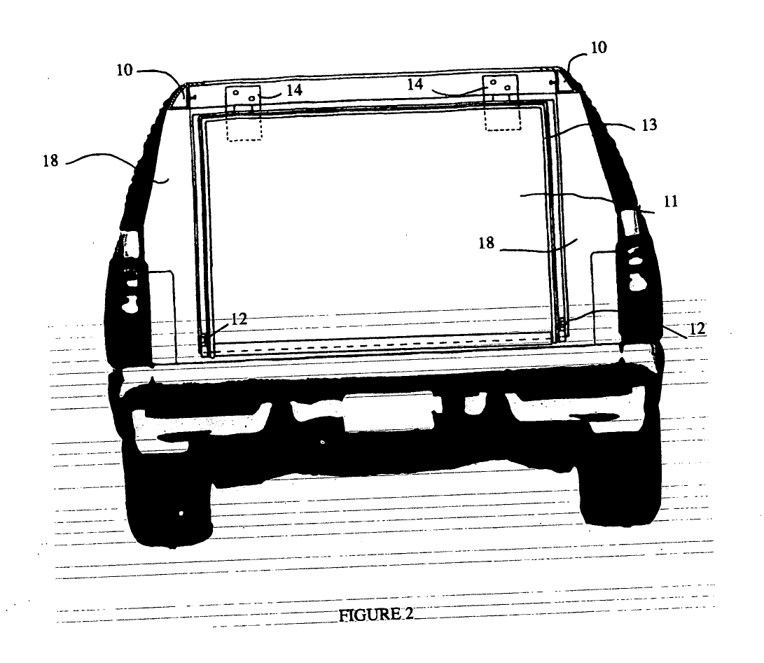

In one exemplary implementation, the roof panel 11 is sized to mate with a bulkhead frame 18 (shown as FIG. 2 and described below). In an exemplary embodiment, the length of 11L of the roof panel 11 is approximately equal to or slightly less than the distance from the roof to the floor. Thus, when the roof panel 11 is open, the free end 11F may be pivoted downwardly so that the roof panel 11 is in a substantially vertical orientation. The free end 11F of the roof panel 11 extends to the back of the rear compartment and abuts the top of the tailgate. As used herein, the term tailgate denotes a gate (e.g., door) at the rear of the vehicle that can be lowered or swung open for access to the rear compartment. Conventional seals may be provided to ensure a weatherproof seal between the free end 11F of the roof panel 11 and the tailgate. The width of the exemplary roof panel 11 (as measured perpendicular to the length 11L) is approximately equal to or slightly less than the minimum width of the interior of the rear compartment (i.e., the distance from one side, e.g., driver's side, of the rear compartment to the other side, e.g., passenger's side) at the bulkhead. The roof panel 11 should fit within the available area and mate with the bulkhead frame 18.

The roof panel 11 preferably includes one or more mechanisms for enabling locking. The exemplary roof panel 11 is configured for locking to the roof 10, as well as to or against the bulkhead frame 18 (as shown in FIG. 2 and described below). By way of example and not limitation, the sides and/o free end of the roof panel 11 may be equipped with lock assemblies 12 or lock strikers 15 configured to engage corresponding locking members at or near the roof 10 and bulkhead frame 18.

FIG. 2 conceptually provides a rear view of a vehicle with a cutaway section of the roof, the roof being equipped with an exemplary hinged roof panel in a vertical (i.e., folded down) position, thereby creating a bulkhead sealing the cargo compartment from the front compartment. As shown in FIG. 2, the roof panel 11 may be unlocked, released from the roof 10 and pivoted about axis A- to expose the roof opening 16.

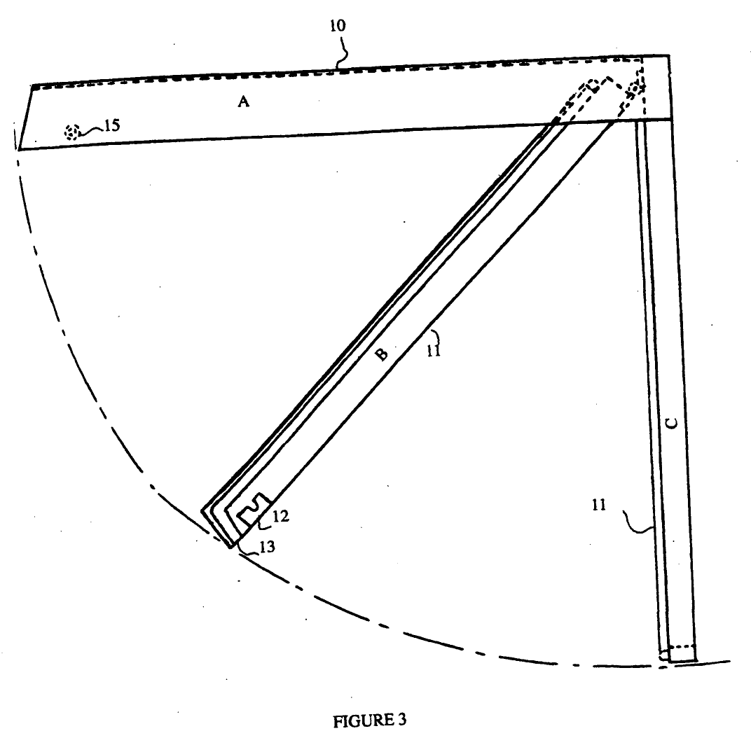

The roof panel may be opened or closed creating an open-air compartment or an enclosed rear compartment, respectively. Referring now to FIG. 3, a side view of a portion of an exemplary hinged roof panel in closed A, intermediate B and opened C positions in accordance with an embodiment of the invention is shown. Opening, closing, locking and unlocking may be performed automatically, such as by using electro mechanical actuators and/or drives, or manually). When the roof panel 11 is released from the roof 10, the roof panel is considered to be opened and the rear compartment is said to be an open-air rear compartment. When the roof panel 11 is locked, sealing the roof opening 16, the roof panel is considered to be closed and the rear compartment is said to be an enclosed rear compartment.

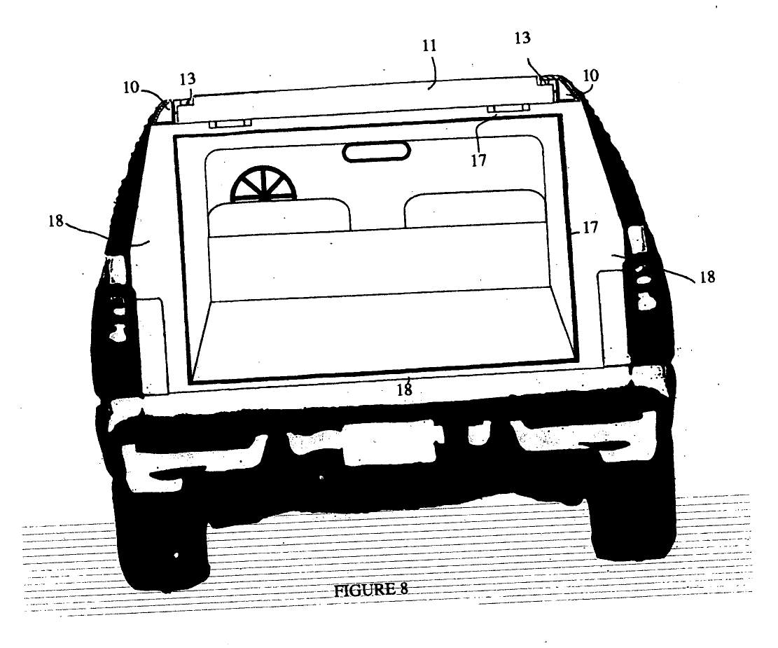

Illustratively, FIG. 8 conceptually provides a rear view of a vehicle with a cutaway section of the roof, the roof being equipped with an exemplary hinged roof panel in a closed position, thereby sealing the roof opening. A seal 17 is provided for enabling weatherproof seal between the roof panel 11 and the bulkhead frame 18.

As shown in FIG. 2, a bulkhead frame 18 partitions the front compartment from the rear compartment. The bulkhead frame 18 defines an opening from receiving the roof panel 11. When the roof panel 11 is locked to the bulkhead frame 18, the roof panel 11 and the bulkhead frame 18 comprise a bulkhead that separates and seals the front compartment from the rear compartment The bulkhead frame 18 may be formed as an integral part of the vehicle's body, or as a separate frame that can subsequently be installed. Additionally, the bulkhead may be comprised of a single integral frame or a plurality of mechanically fastened frame elements.

The bulkhead is sized and shaped to seal the front compartment from the rear compartment. The specific dimensions and shape of the bulkhead from 18 will depend upon the size and shape of the portion of the compartment within which it resides and upon the size and shape of the roof panel 11. The sides of the interior near the bulkhead may be vertically straight, slanted or some other contoured shape. For example, depending upon the vehicle, the width of the rear compartment near the roof at the bulkhead may be different than the width of the rear compartment near the floor at the bulkhead.

The bulkhead, which is comprised of the roof panel 11 and bulkhead from 18, provides several advantages. It protects the front compartment, reduces the level of noise and odors that enter the front compartment, and prevents cargo, soil and the elements from entering the front compartment.

A vehicle equipped with a bulkhead according to an exemplary embodiment of the invention, may include passenger seats in the rear compartment. Thus, the rear compartment may be used to transport passengers while the bulkhead isolates the rear compartment from the front compartment. Dividing the interior into a front passenger compartment and a rear passenger compartment is particularly useful for enhancing privacy, and segregating teenagers and/or loud passengers from quiet passengers. This compartment may also be used to segregate smoker from non-smokers.

The rear compartment may also be convertible into a cargo-carrying compartment. By way of example, the rear compartment may include collapsible or removable seats. Converting the rear compartment to a cargo-carrying compartment may entail removing or collapsing the passenger seats in the rear compartment.

A roof panel 11 according to an exemplary embodiment of the invention performs a plurality of functions. One such function is to comprise a substantial part of the bulkhead. Another function is to seal the roof opening 16, when the roof panel is not functioning as part of the bulkhead. Stationary of movable windows may be installed in the roof panel.

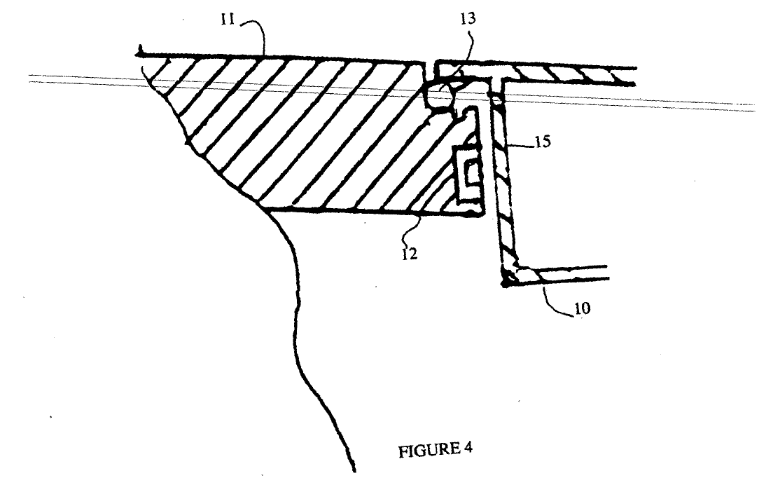

Referring now to FIG. 4, a cutaway section of a portion of an exemplary roof panel and roof section in accordance with an embodiment of the invention is shown. A seal 13 provides a weather-proof gasket between the panel 11 and roof 10.

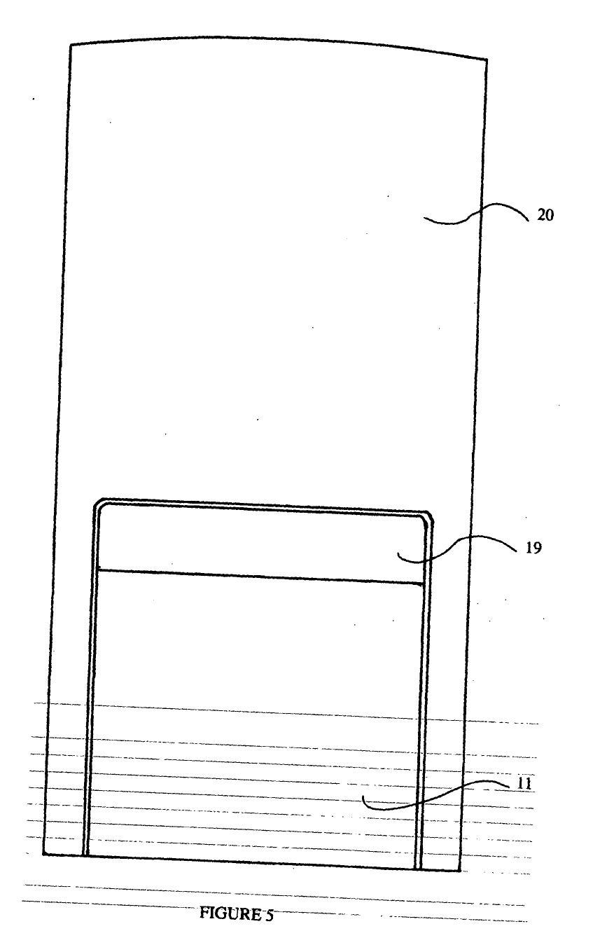

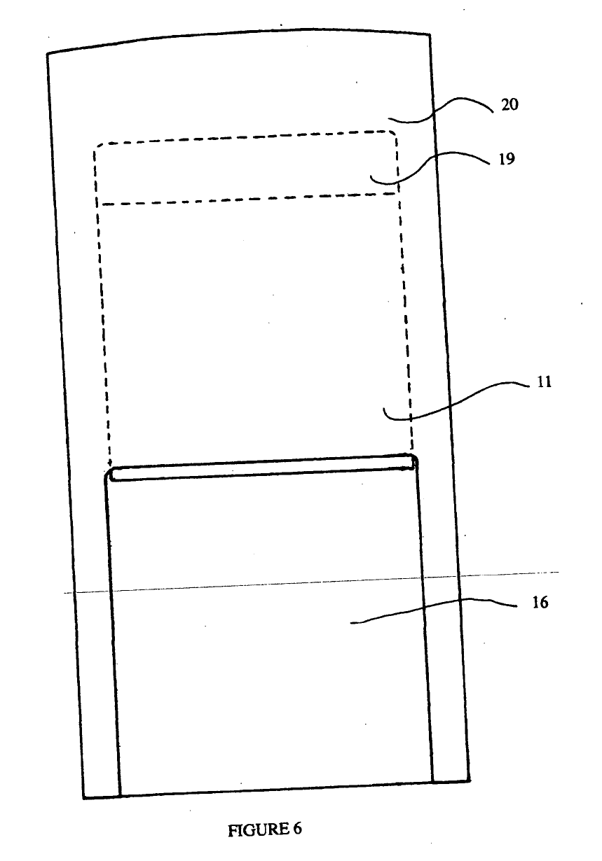

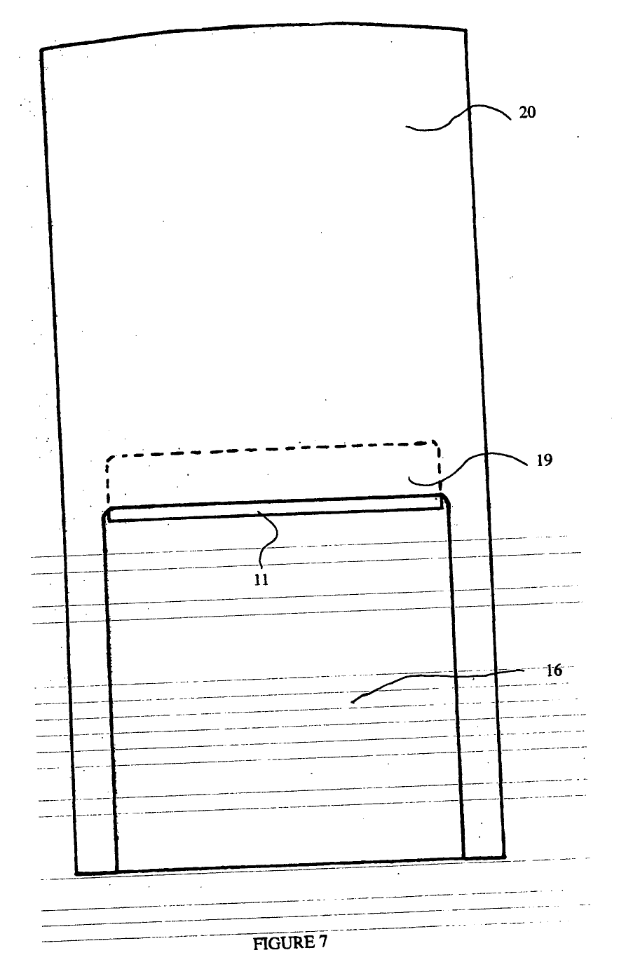

Alternative roof panel configurations which enable roof closure and bulkhead formation come withing the scope of the invention. As an alternative embodiment, the roof panel may be fully or partially retractable. As used herein, retraction refers to sliding motion. A closed retractable roof panel many slide forward, thereby creating an opening. An open retractable roof panel may slide backward, thereby closing the opening. A retractable roof panel may slide into a pocket formed in an adjacent portion of the fixed roof, or may slide substantially parallel to, but slightly above, an adjacent portion of the fixed roof. Retraction of a roof panel may be accomplished in a conventional manner, such as mechanically and/or electromechanically using conventional devices for vehicle sunroofs and moon-roofs. By way of example, FIGS. 5-6 conceptually provide a top view of a portion of a vehicle roof with an exemplary roof panel 11 that may be fully or partially retracted in accordance with an embodiment of the invention. The roof panel may include a plurality of sections 11 and 19, with one section 11 hingedly attached to another section 19, both of which may be retracted substantially parallel to the roof portion 20 creating opening 16.

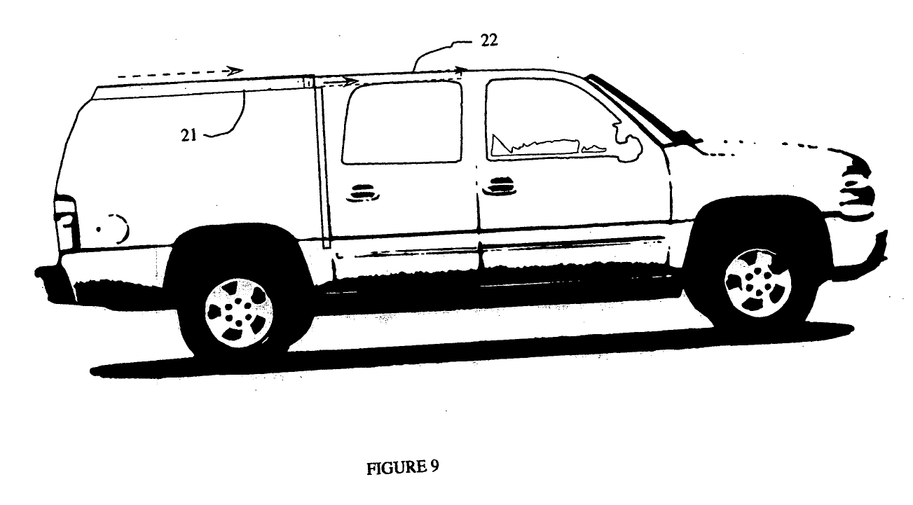

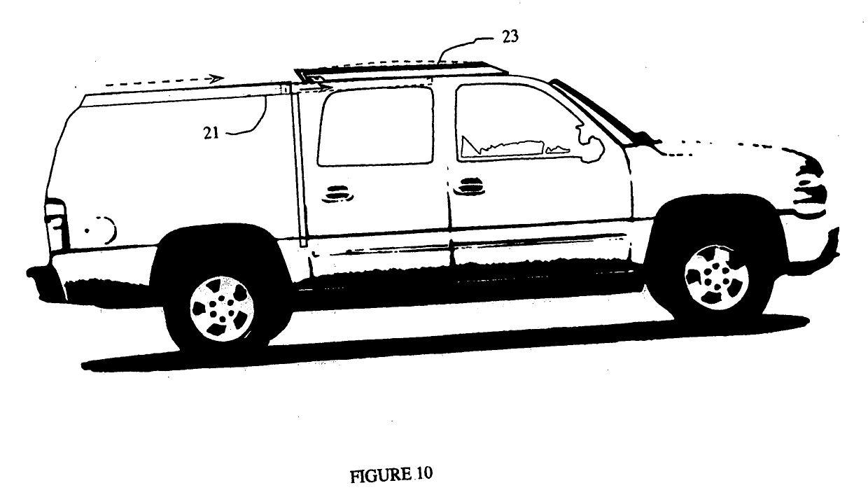

In long vehicles, al alternative embodiment may be used to avoid placement of the bulkhead by the side widows of rear compartment. If the distance from the bulkhead to the tailgate exceeds the distance from the roof to the floor, and the opening 16 defined in the roof 10 above the rear compartment of the vehicle extends from the bulkhead to the tailgate, then the entire roof panel 11 will not fit in the space between the roof and the floor. In such a case, the roof panel 11 may either form a bulkhead that is not substantially perpendicular to the floor and roof, or the roof panel 11 may be partitioned. If the roof panel 11 is partitioned, then one or more of the partitioned sections (the bulkhead portion of the roof panel 11) may provide the structure for the bulkhead, and the other partitioned section may be retracted (i.e., move forward). Each section may be hingedly connected to an adjacent partition, thereby allowing a first section to be retracted (i.e., moved towards the front of the vehicle such as by sliding) while a second section is pivoted downwardly to mate with a bulkhead frame and form a bulkhead. Illustratively, FIG. 9 conceptually provides a side view of a vehicle with a retractable roof panel 21 in a closed position. A compartment 22 is also shown for receiving the panel 21 upon retraction. As another example, FIG. 10 conceptually provides a side view of a vehicle with another retractable roof panel 23 in an opened position. The panel 23 of FIG. 10 moves above the front compartment roof of the vehicle.

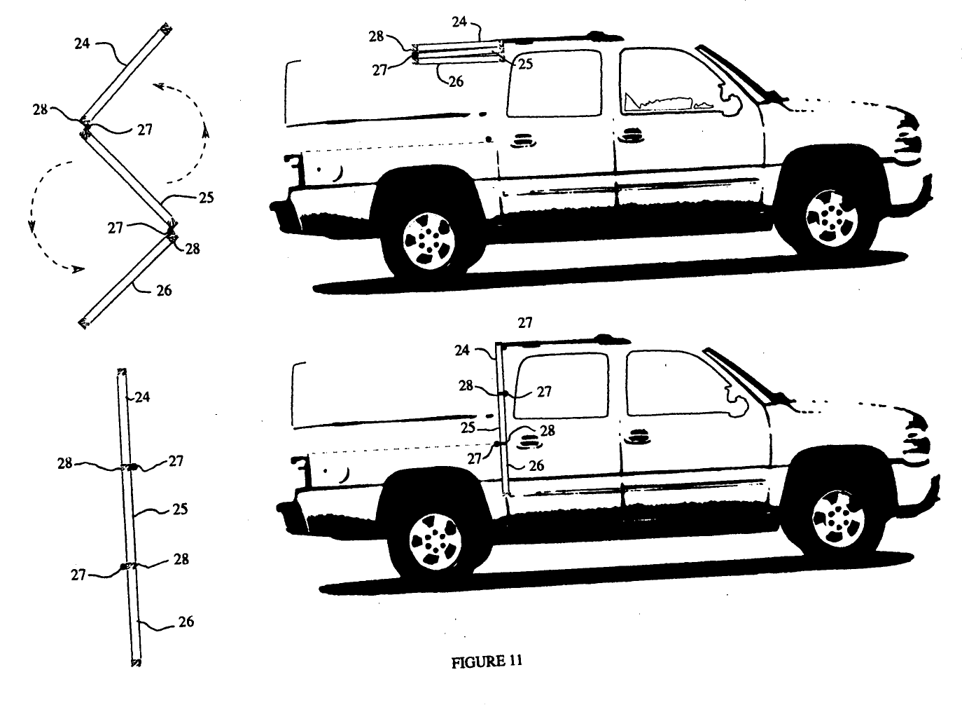

Referring now to FIG. 11, side views of a vehicle with a roof panel having a plurality of hingedly joined sections 24-26 are shown. The panel includes a plurality of hinges 27-28 in addition to hinges 14 for enabling folding and maneuvering of the panel. Advantageously, the flexibility afforded by the plurality of hinges enables the panel to be folded to avoid obstacles, such as passenger seats, which may be in the rear compartment. Thus, the burden of collapsing or removing obstacles to erect the bulkhead is avoided. After avoiding the obstacles and being maneuvered into proximity with the bulkhead from, the panel sections may be unfolded and locked against the bulkhead frame. Subsequently, the panel may be unlocked and released from the bulkhead, folded to avoid obstacles, maneuvered into position at the roof opening, unfolded and locked into place at the roof.

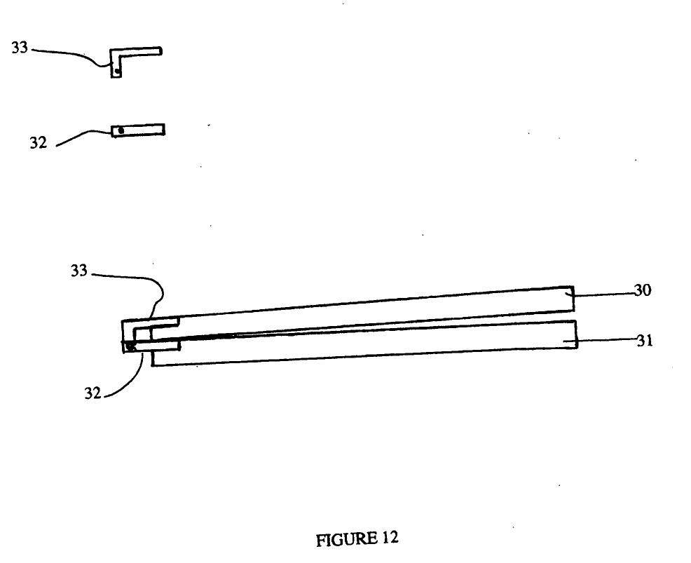

In another alternative embodiment, the roof panel may be comprised of a plurality of panels, such as an exterior panel 30 and an interior panel 31, each of which may be hingedly attached 32, 33 to the fixed roof as conceptually illustrated in FIG. 12. A lock mechanism may be provided to lock the plurality of panels together, to the fixed roof and to the bulkhead frame 18. Additionally, one or more of the plurality of panels 30, 31 may also be retractable. Thus, for example, while an interior panel 31 is maneuvered into proximity with the bulkhead frame and locked against the bulkhead frame, an exterior panel 30 may be closed, thereby sealing the roof opening. Such a configuration is useful for protecting cargo, peters and passengers in the rear compartment from the elements, while isolating them from the front compartment. Of course, if the exterior panel 30 is independently retractable, it may be retracted to open the roof while the interior panel 31 is locked against the bulkhead frame 18. In another configuration, both the exterior 30 and interior panels 31 may be maneuvered into proximity with the bulkhead frame 18 and locked against the bulkhead frame 18. Using an L-shaped hinge member 33 enables the exterior panel 30 to remain aligned with the interior panel 31, while they are locked against the bulkhead 18 and while they are locked to the fixed roof. Additionally, if the interior and exterior panels re retractable, they may be retracted to open the roof. Thus, the rear compartment may be converted between an open-air configuration and an enclosed configuration using the exterior roof panel, while the interior roof panel is locked against the bulkhead frame.

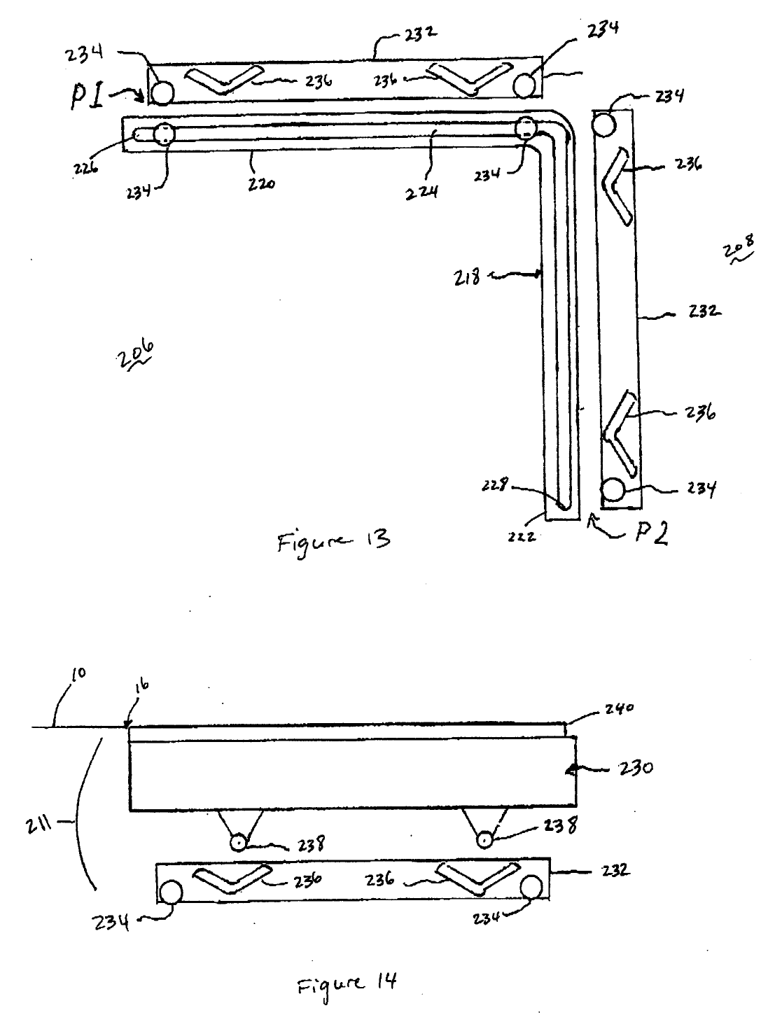

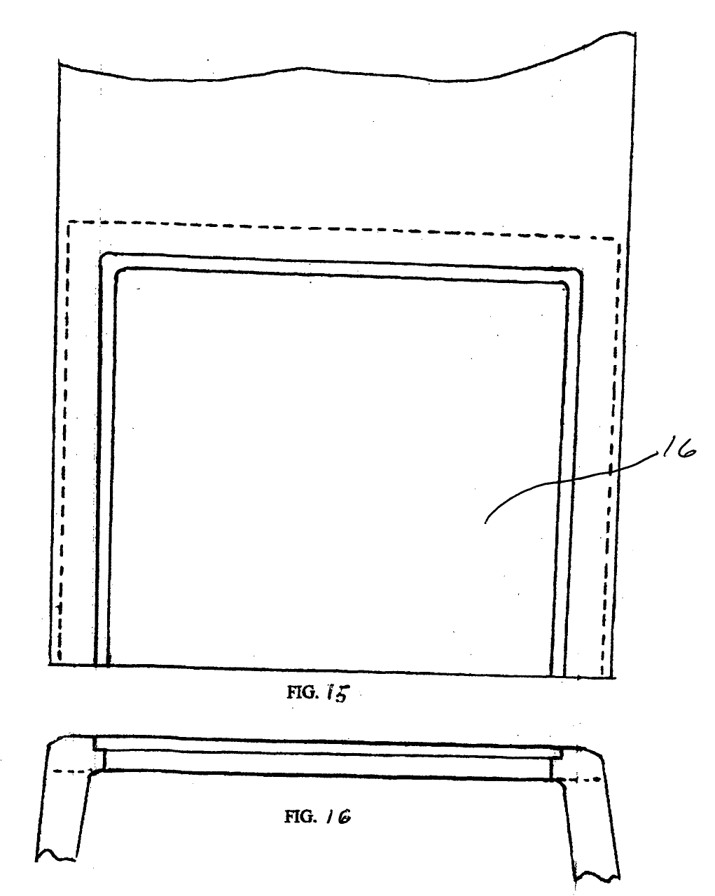

In another alternative embodiment, the bulkhead frame 218 is disposed between the front compartment 206 and the rear compartment 208 of the interior of the vehicle, as illustrated in FIGS. 13-14. A roof panel 211 is operatively connected to the bulkhead frame 218 where by the roof panel 211 is movable between an open, first position P1 and a closed second position P2.

The bulkhead frame 218 has opposing L-shaped members disposed adjacent to the side walls of the vehicle, as shown in FIG. 13. Each L-shaped member of the bulkhead frame 218 has a substantially horizontal leg 220 and a vertical leg 222. A continuous track 224 is formed through both the horizontal and vertical legs 220-222 of the bulkhead flame 218. The track 224 is adapted to receive the roof panel 211 so as to provide a guide as well as limit the movement of the roof panel 211 along the length of the track 224. The roof panel 211 is movable along the length of the continuous track 224 formed in the bulkhead frame 218 between a first position P1 and a second position P2. When in the first position P1, the roof panel 211 is oriented in a substantially horizontal manner, and when in the second position P2, the roof panel 211 is oriented in a substantially manner. The translated movement of the roof panel 211 relative to the bulkhead frame 218 is limited by a first stop 226 located at one end of track 224 and a second stop 228 located at the opposite end of track 224.

The roof panel 211 includes a cover 230 operatively attached to a trolley 232, as shown in FIGS. 13-14. The trolley 232 includes at least two rollers 234 attached to each lateral edge of the trolley 232, wherein the rollers 234 are received within the track 224 of bulkhead frame 218 so as to allow the roof panel 211 to translate the first and second positions P1-P2. A roller 234 is disposed adjacent to each distal end of the opposing side edges of the trolley 232, but can be located at any other location on the side edges of the trolley 232 sufficient to allow the roof panel 211 to translate around the corner formed by the horizontal and vertical legs 220 and 222 of the bulkhead frame 218. When the roof panel 211 is in the first position P1, the forwardmost roller 234 on trolley 232 is adjacent to the first stop 226 of the track 224. When the roof panel 211 is in the second position P2, the rearwardmost roller 234 on the trolley 232 is adjacent to the second stop 228 of track 226. The trolley 232 further includes a pair of v-shaped cams 236 that extend from both opposing lateral side edges of the trolley 232. Each v-shaped cam 236 attached to the trolley 232 is adapted to receive a corresponding pin 238 operatively attached to the cover 230.

The cover 230 of the roof panel 211, as shown in FIG. 14, includes a slidable body 240 having a plurality of pins 238 operatively thereof. The pins 238 are adapted to be received by a v-shaped cam 236 disposed on the trolley 232. The body 240 of cover 230 has a shape and sufficient to be received in an opening 16 of the roof 10 such that when the trolley 232 is in the first position P1, the cover 230 forms a sealed engagement with the roof opening 16. The body 240 of the cover 230 is adapted to be received within the opposing vertical legs 222 of the bulkhead flame 218 such that when the trolley 232 is in the second position P2, the cover 230 forms a sealed engagement with the bulkhead frame 210 so as to separate the front compartment 206 from the rear compartment 208. The roof panel 211 is manually actuated between the first position P1 and the second position P2 using electromechanical actuators or drives, pulleys and levers, or any other mechanism sufficient to mechanically actuate the roof panel 211.

In operation, when the roof panel 211 is actuated to the first position P1, the 230 contacts the roof opening 16 prior to the forwardmost roller 234 on trolley 234 abut the first stop 226 of track 224. As the trolley 232 continues to translate toward the first stop 226, the edge of the roof opening 16 prevents the body 240 of the cover from translating therewith. As a result the pins 238 attached to the cover 230 translate upwardly along the inclined surface of the respective v-shaped cam 236, thereby causing the body to be raised relative to the roof 10. The raising movement of the body 240 results in a snug abutting engagement between the body 240 of cover 230 and the roof opening 16 such that a seal is produced between the cover 230 and the roof opening 16. The rollers 234 translate along the track 224 until the forwardmost rollers 234 on the trolley 234 are in abutting engagement with the first stop 226. The trolley 234 is maintained in this position P1 to ensure the sealed engagement between cover 230 and the roof 10 until the user releases the rollers 234 from the abuttingengagement with the first stop 226.

In a similar manner, as the roof 211 is translated from the first position P1 to a second position P2, the rollers 234 translate along the length of the track 224. As the reawardmost rollers 234 approach the second stop 228 of the track 224, the cover 230 contacts the bulkhead frame 218 located adjacent to the floor of the vehicle and extends between the sides thereof. As the trolley 232 continues to translate along the track 224, the pins 238 translate upwardly along the inclined surface of the respective v-shaped cam 236 opposite the inclined surface along which the pins 238 traveled when locating the roof panel 211 in the first position P1, thereby causing the body 240 to be raised relative to the trolley 232. The rasing movement of the body 240 relative to the trolley 232 results in a snug, abutting engagement between the body 240 of the cover 230 and the bulkhead frame 218 such that a seal is produced between the roof panel 211 and the bulkhead frame 218. As a result, the rear compartment 208 is separated from the front compartment 206.

In another alternative embodiment, shown in FIGS. 15-16 is a kit for aftermarket installation by the average handy man. The roof panel 11 is removed manually from the roof opening 16, it may be held in place with conventional lock mechanism. The roof panel 11 may be manually engaged with bulkhead frame 18 and locked into position, sealing the front compartment from the rear compartment. This is a simple and inexpensive method of converting an inclosed vehicle into a convertible inclosed vehicle or an open-air vehicle merely by moving the roof panel 11 from the roof to a position in the bulkhead frame separating the front compartment from the rear compartment.

Some or all hinges and hinged connections of roof panels may be detachable, using detachable hinge connections for automotive applications as is known in the art. Detachability enables removal of the panel or panels for storage and/or maintenance.

In addition to being convertible between an open-air configuration and an enclosed configuration as discussed above, the rear compartment may be convertible between a passenger-carrying compartment and a cargo-carrying compartment. A default configuration may include collapsible or removable passenger seats. Thus, while the passenger seats are in place, the rear compartment functions as a passenger-carrying compartment. When the passenger seats are removed or collapsed, the rear compartment functions as a cargo-carrying compartment.

Those skilled in the art will appreciate that the invention may readily be implemented as original equipment in new vehicles. Additionally, without departing from the scope of the invention, a kit may be provided for aftermarket adaptation of components of the invention to vehicles.

While the invention has been described in terms of exemplary embodiments, those skilled in the are will recognize that the invention can be practiced with modifications within the spirit and scope of the foregoing detailed description. Such alternative embodiments and implementations are intended to come within the scope of the present invention,

Having thus described embodiments of the invention, what is claimed is as follow:

1. A motor vehicle having a roof and an interior compartment, said interior compartment including a front area and a convertible rear area, said motor vehicle including:
a roof opening above the rear area;
a roof panel assembly above the rear area, said roof panel assembly being pivotally connected to the roof of the vehicle, and said roof panel assembly being adapted for pivotal movement between a first closed position covering the roof opening; and
a bulkhead frame in the interior compartment between the passenger and rear areas, said bulkhead frame being adapted to receive the roof panel assembly when the roof panel assembly is pivotally moved into a second closed position.

2. A motor vehicle according to claim 1, wherein said roof panel is in sealed engagement with a roof opening when said roof panel is located in said first sealed position.

3. A motor vehicle according to claim 1, wherein said roof panel is in sealed engagement with said bulkhead frame when said roof panel is located in said second sealed position such that said front compartment is separated from said rear compartment

4. A motor vehicle according to claim 1, wherein said roof opening and said bulkhead frame include a track formed to transport said roof panel from a first sealed position in said roof opening, to a second sealed position in said bulkhead frame such that said front compartment is separated from said rear compartment.

5. A motor vehicle according to claim 4, wherein said roof panel includes a trolley and cover operatively connected to said trolley.

6. A motor vehicle according to claim 5, wherein at least one roller is attached to said trolley, said roller is movable within said track formed between said bulkhead frame and said roof opening.

7. The motor vehicle according to claim 5, wherein at least one pin attached to said cover and said pin is received by a corresponding v-shaped cam attached to said trolley.

8. The motor vehicle according to claim 7, wherein as said trolley is moved toward said first sealed position, said cover contacts a roof opening and as said trolley continues to move toward said first sealed position, said at least one pin moves within said corresponding v-shaped cam thereby causing said cover to be raised relative to said trolley such that said cover forms a sealed connection with said roof opening.

9. The motor vehicle according to claim 8, wherein as said trolley is moved toward said second sealed position, said cover contacts said bulkhead frame and as said trolley continues to move toward said second sealed position, said at least one pin moves within said corresponding v-shaped cam thereby causing said cover to be raised relative to said trolley such that said cover forms a sealed connection with said bulkhead frame.

10. A motor vehicle according to claim 1, wherein said roof panel is manually movable between said first sealed position and said second sealed position.

11. A motor vehicle according to claim 1, wherein said roof panel is movable between said sealed position and said second sealed position by way of an electromechanical mechanism.

12. A motor vehicle according to claim 1, wherein said roof panel assembly includes an interior roof panel and an exterior roof panel, said interior roof panel may be adapted to lock to said exterior roof panel.

13. A motor vehicle according to claim 1, wherein said roof panel assembly includes a means for slidable motion and includes a rear portion hingedly attached to a front portion, said roof panel assembly having sealed engagement with a roof opening when said roof panel assembly is located in said first sealed position, said roof panel assembly is in sealed engagement with said bulkhead frame when said roof panel assembly is located in said second sealing position.

14. A motor vehicle according to claim 13, wherein said roof panel assembly is slidably movable and is parallel to the roof of said front compartment of said vehicle.

15. A motor vehicle according to claim 1, wherein said front area being adapted to carry at least a driver and said rear area being open-air and adapted to carry cargo.

16. A motor vehicle according to claim 1 wherein said front area being adapted to carry at least a driver and said rear area being enclosed and adapted to carry passengers.

17. A motor vehicle according to claim 1, wherein said front area being adapted to carry at least a driver and said rear area being open-air and adapted to carry cargo.

18. A motor vehicle according to claim 1, wherein said front area being adapted to carry at least a driver and said rear area being enclosed and adapted to carry cargo.

19. A motor vehicle according to claim 1, wherein said roof panel is manually detachable from from said roof opening.

20. A motor vehicle according to claim 1, wherein said roof panel may be manually attached to said bulkhead frame, sealing said front compartment from said rear compartment.

21. An aftermarket conversion kit for a motor vehicle a roof and an interior compartment, said interior compartment including a front area and a rear area, said kit including;
a opening in said roof, a roof panel and a bulkhead frame to separate said front compartment from said rear compartment; and
a bulkhead frame to enable locking of said roof panel against the bulkhead frame when the roof panel is in the second position
